(19) United States
(12) Patent Application Publication
(10) Pub. No.: US 2008/0270911 A1
(43) Pub. Date: Oct. 30, 2008

(54) SYSTEM AND METHOD TO DEVELOP A CUSTOM APPLICATION FOR A MULTI-FUNCTION PERIPHERAL (MFP)

(76) Inventors: Nehal Dantwala, Newport Beach, CA (US); Shahzad Bhatti, Tustin, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/739,598

(22) Filed: Apr. 24, 2007

(51) Int. Cl. G06F 3/01; G06F 17/00

(52) U.S. Cl. 715/741; 726/12

(57) ABSTRACT

In general, the invention relates to adding custom applications to multi-function peripheral (MFP) devices. In some embodiments, a proxy device is used to provide registration and routing functions to third-party applications operating on host sites. Thus, the proxy device relieves the MFP device of the processing burden associated with application registration and message routing between multiple custom applications and the MFP device. In some embodiments, user interface (UI) templates are used to customize application displays on the MFP device. By using standard templates, such as templates based on XML, the MFP devices may include minimal support for parsing the templates, thereby reducing the burden placed on the device to accommodate the custom applications.

### BACKGROUND OF THE INVENTION

1. Field of the Invention

The invention relates to multi-function peripherals (MFPs). More particularly, the invention relates to facilitating the development of custom applications for a multi-function peripheral.

2. Description of the Related Technology

As businesses continue to make MFPs part of their business processes, customization of MFP devices can become a fundamental requirement. Custom applications range from printing applications that insert a barcode on every page to scanning applications where forms are processed and data is extracted before archival on backend databases, for example.

MFP vendors have taken different directions for offering MFP customization, including embedded and host-based solutions. In general, embedded solutions provide customization as implemented in the MFP device itself. In general, host-based solutions provide customization at a host computer in data communication with an MFP, thereby accessing the native functions of the MFP device.

In an embedded platform, customization occurs via the compute environment of the MFP device, providing application programming interfaces (APIs) and software development kits (SDKs) to build the applications. APIs provide access to an MFP device's User Interface (UI) for UI customization. APIs are made available for scan, print and other native device functionality. Space is allocated on hard disk as well as memory to mount and execute custom applications. Customized solutions may be entirely contained within the MFP device.

In host-based platforms, most of the execution for customization occurs on a host computer. Host-based solutions may also offer extensive APIs and infrastructure support. For host-based solutions, there needs to be infrastructure in place to access custom UIs and other native functionality.

In some target markets, such as a work group segment, users do not demand extensive customization capabilities. Furthermore, for some markets, MFP devices are not ready to offer extensive support. In such cases, extensive APIs and infrastructure support may be overkill or may not be feasible.

Hence, there is a need to provide customization of MFP devices with minimal impact to the MFP device itself.

### SUMMARY OF CERTAIN INVENTIVE ASPECTS

In general, aspects of the invention relate to multi-function peripherals (MFPs). Specifically, embodiments of the invention relate to facilitating customization of multi-function peripherals.

One aspect is a method of customizing MFPs comprising exposing functionality, through a software interface, of an MFP device to one or more custom applications hosted on one or more devices remote to the MFP device; and providing a proxy device to register the one or more custom applications for use by users of the MFP device.

Another aspect is a method of executing a custom application on an MFP comprising registering the custom application on a proxy device in data communication with the MFP; making the registered custom application available to MFP users based on communication between the MFP and the proxy device; receiving, via the MFP, data from an MFP user; and routing, through the proxy device, the data from the MFP to a host device hosting the custom application.

Yet another aspect is a system for providing custom applications on MFPs comprising an MFP, wherein the MFP functionality is exposed, through a software interface, to one or more custom applications hosted on other devices; and a proxy device, the proxy device configured to register the one or more custom applications for use by users of the MFP.

Yet another aspect is an MFP that supports custom applications comprising an MFP device, the MFP device configured to interface with one or more custom applications executed on other devices, and the MFP device fisher configured to make the one or more custom applications available to users of the MFP device after receiving an update from a proxy device indicating that the proxy device has registered the one or more custom applications for use on the MFP device.

Yet another aspect is a method of providing custom applications on MFPs comprising defining a template for user input at an MFP, the template comprising a set of configurable user interface features; receiving machine readable instructions originating from a custom application operating on a device other than the MFP, the machine readable instructions specifying user interface settings; determining whether the received instructions correspond to the defined template; and if there is a correspondence, configuring a user interface of the MFP based on the specified user interface settings.

Yet another aspect is a computer readable medium having machine loadable software for MFP application customization, wherein the software is configured to perform a method comprising defining a template for user input at an MFP, the template comprising a set of configurable user interface features; receiving machine readable instructions originating from a custom application operating on a device other than the MFP, the machine readable instructions specifying user interface settings; determining whether the received instructions correspond to the defined template; and if there is a correspondence, configuring a user interface of the MFP based on the specified user interface settings.

Yet another aspect is an MFP that supports custom applications comprising an MFP device, the MFP device configured to interface with one or more custom applications executed on other devices, and the MFP device further configured to arrange its user interface display based on XML-based instructions corresponding to one or more predefined templates, the MFP device receiving the XML-based instructions from the one or more custom applications.

### BRIEF DESCRIPTION OF THE DRAWINGS

FIGS. 1A and 1B are system-level diagrams illustrating the registration of a custom application for an MFP device.

FIG. 1C is a flowchart of one embodiment of customizing an MFP.

FIG. 2 is a block diagram that illustrates one embodiment of the exchange of messages between an MFP device, a proxy device and a custom application operating on a host site.

FIG. 3 is a flowchart of one embodiment of customization operations on an MFP device, a proxy device and a custom application.

FIG. 4 is one embodiment of a registration dialog window.

FIG. 5 illustrates one embodiment of available user interface (UI) templates.

FIGS. 6A, 6B, 6C, 6D and 6E illustrate embodiments of dialog windows for a particular custom application.

### DETAILED DESCRIPTION OF THE CERTAIN INVENTIVE EMBODIMENTS

Various aspects and features of the invention will become more fully apparent from the following description and the pending claims taken in conjunction with the foregoing drawings. In the drawings, like reference numerals indicate identical or functionally similar elements. The drawings, associated descriptions, and specific implementation are provided to illustrate the embodiments of the invention and not to limit the scope of the disclosure.

In general, the invention relates to methods, systems, and software for implementing customization of multi-function peripherals (MFPs). Embodiments of the invention are directed to creating custom applications on MFPs using host-based web services and minimal embedded infrastructure support. Embodiments disclosed herein enable third-party application providers to make their scan-related applications available on the MFP device, and applications can be initiated from the device, as well as any subsequent user interaction.

In general, a multi-function peripheral (MFP) device is a single integrated device configured to perform two or more functions, including without limitation scanning, copying, printing, faxing, combinations of the same and the like. The functionality of a MFP device may be accessed over a network, including, for example, the Internet or a LAN, or at the device itself. A MFP device may be configured with sufficient memory to queue jobs waiting to be processed. It will be appreciated that MFP devices may be configured to perform in a variety of different networked and standalone computing environments,

In order for a third-parties to be able to develop applications for an MFP device, after that device as already been released, the device may provide an infrastructure that allows third parties to link their applications to the device. These applications are referred to, generally, as custom applications. In general, a custom application may be any suitable program application that provides additional and/or supplementary functionality to an MFP.

In one embodiment, third-party applications use the MFP device UI in order to gather the user-related information, including any metadata. This data is then transferred to the site hosting the third-party application, and the data is processed at the host. Thus, there is an exchange of information between the MFP device and the third-party applications. In one embodiment, the typical exchange may be as follows: a user selects a specific application at the MFP device; the device is unable by itself to process the application; the device requests the next operation from the host-side application; the application responds by providing the next steps including any UI screens that need to be shown to the user; the device then shows any necessary screens to the user; the user then fills in any appropriate values on the screen and selects next; and the device sends the user data to the application. This sequence (the exchange of requests, user data, and UI screens) continues until the application receives all the desired data. In one embodiment, once all the data has been collected, the user accesses the native functionality of the MFP device, and the custom application operating on the host site processes, for example, the scanned data according to the data instructions previously provided by the user. For example, a custom application may take a scanned document, examine the data in the document with optical character recognition (OCR) software, and store any relevant data to a database.

In one embodiment, the back and forth exchange between the MFP device and the third-party application may be called a button response system. In one embodiment, a MFP device with Web Service capabilities may be interfaced directly with third-party applications on host sites. In another embodiment, a proxy device may be used as a helper. A proxy device may implement Web Services that interact with third-party applications. Using a proxy device may relieve some of the processing burden of the MFP device that would otherwise be required to process the Web Services. In one embodiment, a proxy device sends the requests from the MFP device to the respective third-party applications and vice versa.

In one embodiment, MFP device customization may be implemented by providing device UI customization. In one embodiment, third-party applications are provided a set of templates for customizing the UI screens at the MFP device. These templates, for example, allow third-party application writers to use buttons, labels, drop-down menus, text boxes and so forth to create UI screens. In one embodiment, a MFP device may include a UI component that deciphers and displays the UI screens based on the templates received from the third-party applications. In one embodiment the UI component may be implemented in hardware and/or software. Providing UI templates may offer a level of customization without embedding a full-fledged HTML browser into the device. Certain embodiments of the invention, however, may implement increased customization, including HTML browser capabilities. In one embodiment, the UI component is an XML parser and the UI templates are XML based. It will be appreciated by one skilled in the relevant technology that certain embodiments may use other suitable formats that may be deciphered by the device and understood by third-party applications.

In one embodiment, third-party application developers provide the Web Service to support the button response system. The application writers may also create the UI screens based on the provided screen templates, and the application writers may also provide the screen sequence.

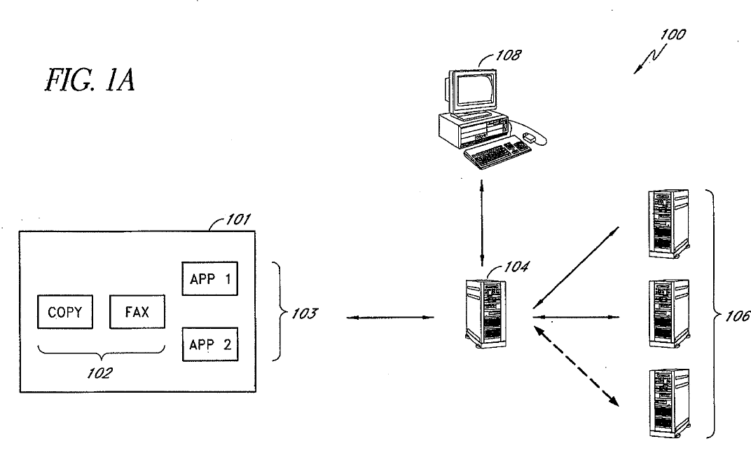

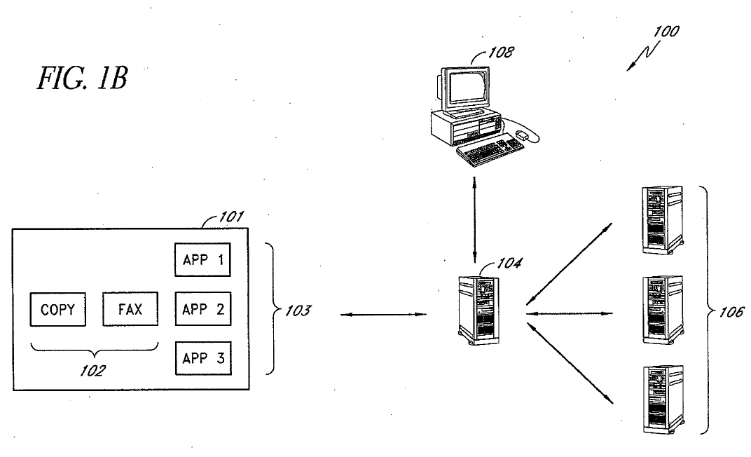

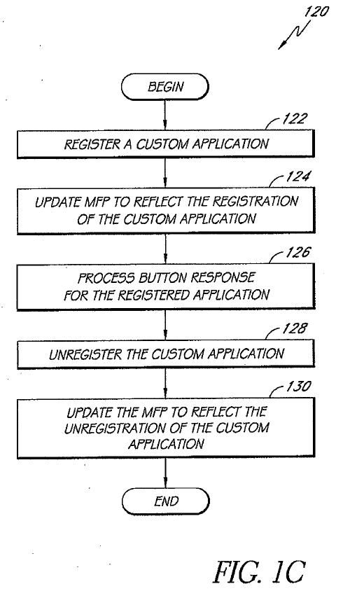

FIGS. 1A and 1B illustrate the registration of a custom application on a MFP device. The customizable MFP system 100 includes an MFP device 101 capable of performing native functions 102 and application specific functions 103. The MFP device 101 is in data communication with a proxy device 104, which communicates with custom applications operating on host servers 106. In one embodiment, an administrator may access the proxy device 104 through a client device 108. Although not illustrated, the MFP device 101, the proxy device 104, the host servers 106, and the client device 108 may be interconnected through various networks, including the Internet, a local intranet, wireless networks, wired networks, local area networks (LANs), wide area networks (WANs), combinations of the same, and so forth. Furthermore, although in the illustrated embodiment, each custom application is illustrated as operating on a respective host server 106, in other embodiments, multiple custom applications may operate on a given host server 106. Moreover, a custom application may operate on several host servers 106, providing the custom application over a distributed network of computing devices. Custom applications may be Web Services. In some embodiments, the interface between the MFP device 101, the proxy device 104, and the custom applications may be defined by the Web Services Description Language (WSDL). Although in the illustrated embodiment the customizable MFP system 100 comprises a proxy device 104, in some embodiments the functionality of the proxy device may be provided by the MFP device 101 and/or the custom applications.

The MFP device 101, the proxy device 104, the host servers 106, and the client device 108 may comprise, respectively, one or more software programs that are executed by one or more processors of the respective device(s)/server(s). Such processors may have a configuration based on Intel Corporation's family of microprocessors, such as the Pentium family. Additionally and/or alternatively, the MFP device 101, the proxy device 104, the host servers 106, and the client device 108 may comprise, respectively, logic or software instructions embodied in hardware or firmware. It will be further appreciated that hardware may be comprised of connected logic units, such as gates and flip-flops, and/or may be comprised of programmable units, such as EPROM, EEPROM, programmable gate arrays or processors. Further, the hardware may comprise a stand-alone dedicated device or general purpose computer with executable software.

In FIG. 1A the MFP device 101 has two custom application functions 103 registered with the device. These two applications, APP1 and APP2, correspond respectively to the custom applications operating on the two topmost illustrated host servers 106. Because these custom applications are registered with the MFP device 101 (and, therefore, accessible to a user), the connections between the respective host servers 106 and the proxy device 104 are represented by solid arrows. The host server 106 illustrated with a dotted line connecting it to the proxy device 104 represents a custom application that is being registered with the MFP device 101. In one embodiment, an administrator may log in to the client device 108 and request that the proxy device 104 initiate a registration procedure to register the custom application operating on, for example, the bottommost host server 106. The registration process is discussed in greater detail below with reference to FIG. 4. FIG. 1B illustrates the customizable MFP system 100 following the registration of the custom application operating on the bottommost host server 106. Following registration, three custom application functions 103 are visible and available to a user on the MFP device 101, and a solid line now connects the bottommost host server 106 to the proxy device 104.

FIG. 1C illustrates a flowchart of one embodiment of customizing an MFP. The customization flowchart 120 shows system states that correspond to the registration, execution, and un-registration of a custom application. In state 122, a custom application is registered. In some embodiments, this registration may be executed on a proxy device, such as proxy device 104. In some embodiments, an MFP user, such as an administrator, may access a proxy device through, for example, a client device, such as client device 108. Through an interface provided by the proxy device, the user may register one or more custom applications to be made available on an MFP, such as MFP device 101. FIG. 4 and the accompanying text illustrate one embodiment of a dialog window of a Web client interface for registering custom applications on an MFP. Additionally and/or alternatively, the user, such as an administrator, may directly interface with the proxy device, such as proxy device 104, using a user interface native to the proxy device. Moreover, in some embodiments, custom applications may be registered directly with an MFP device, obviating registration through a proxy device.

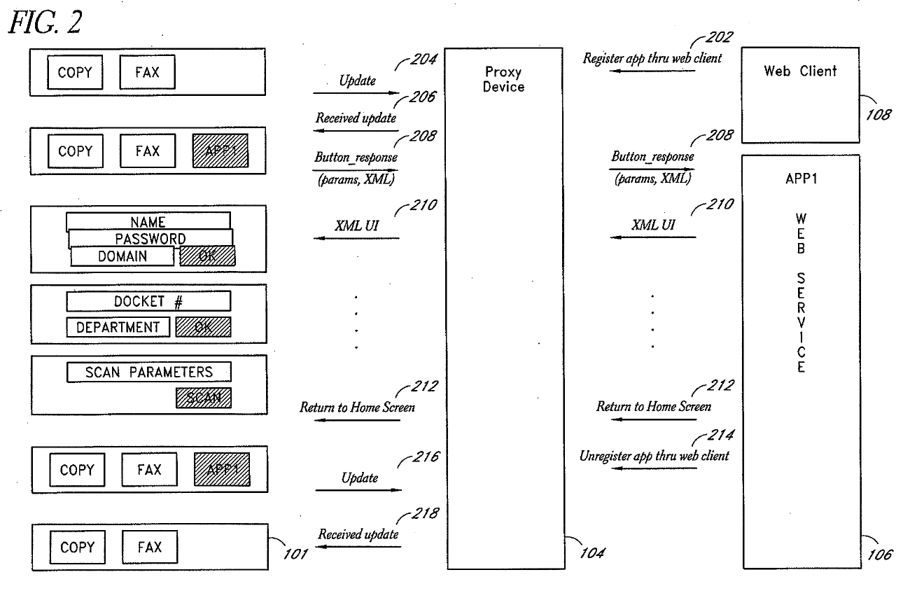

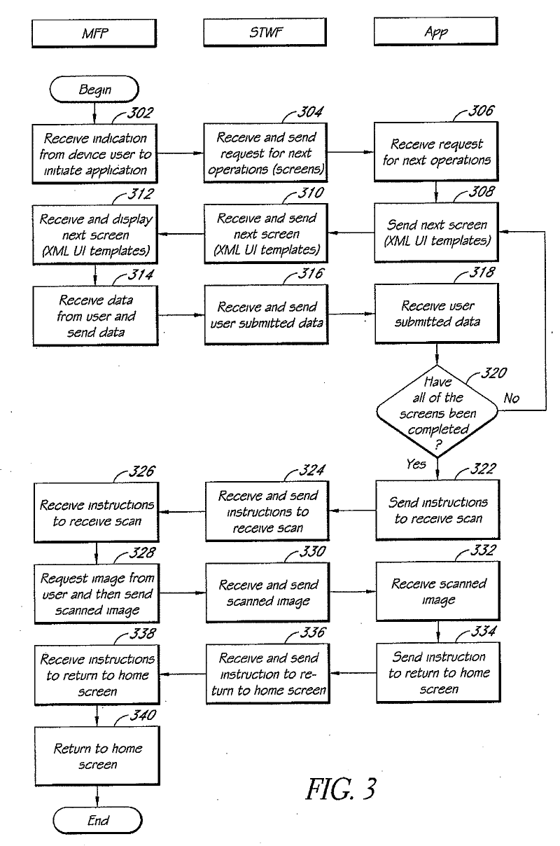

In state 124, the registered custom application is made available to the relevant MFP users, such as the users of MFP device 101. The relevant MFP, such as MFP device 101, is updated to reflect the registration of the custom application. In state 126, a user requests the available custom application, which initiates an exchange between the relevant MFP and the relevant custom application. This exchange may be called the button response system. In response to the users request for the application, the relevant MFP requests the services of the custom application. In some embodiments, the custom applications may be made available as Web Services operating on devices other than the MFP. This exchange is described in greater detail below with reference to FIGS. 2 and 3.

In state 128, the custom application is unregistered. In some embodiments, a user, such as an administrator, may un-register a custom application by interfacing with a proxy device, such as proxy device 104, through a client device, such as client device 108. In other embodiments, un-registration (as well as registration) may occur automatically, periodically, or according to static or dynamic conditions. In state 130, the relevant MFP is updated to reflect that the custom application has been unregistered. The relevant custom application is no longer available to users of the relevant MFP until, for example, the application is reregistered.

FIG. 2 illustrates the exchange of messages between the MFP device 101, the proxy device 104, a host server 106 and a client device 108. Shaded buttons in FIG. 2 indicate that a user has selected the respective shaded button. In state 202, a user, such as an administrator, registers a custom application through the web client program operating on client device 108. The registration process is discussed in greater detail below with reference to FIG. 4. Following state 202, the custom application is registered with the proxy device 104. The proxy device 104 handles registration of custom applications and further routes messages to and from the MFP device 101 with the registered custom applications. In state 204, the MFP device 101 queries the proxy device 104 for any updates, meaning any newly registered custom applications. In state 206, the proxy device 104 sends a message to the MFP device 101, indicating that a new custom application has been registered on the proxy device 104. The new custom application is identified as the APP1 application. As illustrated, following the update from the proxy device 104, the MFP device 101 makes the APP1 custom application available to MFP users. In one embodiment, the interface between the MFP device 101 and the APP1 application is defined by the Web Services Description Language (WSDL). As mentioned above, although in the illustrated embodiment the registration operations are executed on the proxy device 104, in other embodiments registration may be executed on an MFP, such as MFP device 101.

Once the MFP device 101 makes the APP1 custom application available to a user, the user may select the APP1 custom application, initiating the button response system for the APP1 application. In state 208, the user requests the APP1 custom application and the MFP device 101 sends a message to the proxy device 104 requesting instructions from the APP1 custom application. The proxy device 104 transmits the message to the appropriate host server 106, in this case the host server 106 corresponding to the APP1 custom application. In state 210, the APP1 custom application operating on the respective host server 106 sends a message with instructions for a UI screen to be displayed on the MFP device 101. In the illustrated embodiment, the UI instructions conform to XML-based templates that the MFP device 101 has been configured to recognize. In one embodiment, the template requirements may be published to third-party application developers, who can subsequently write UI instructions that conform to the defined templates that the MFP device 101 has been programmed to recognize. In one embodiment, custom applications may deliver template parameters in a parameter list passed to the MFP device 101. Additionally and/or alternatively, custom applications may deliver template parameters in a file that corresponds to a recognized format by the MFP device 101.

The proxy device 104 transfers the instructions to the MFP device 101. The MFP device 101 parses the UI instructions and displays an appropriate screen to the user. After the MFP device 101 displays the respective UI instructions, the user may enter data through the input capabilities of the MFP device 101. For example, the user may type on a keyboard or number pad, may choose buttons on a screen interface, use a stylus to write numbers, characters, and/or symbols or to choose electronic display options, or any other suitable means for entering data. This information is then transferred to the proxy device 104 and then to the respective host server 106, similar to the message sent in state 208. In response, the host server 106 sends additional UT instructions to the in the MP device 101 through the proxy device 104, similar to the message sent in state 210, Although in the illustrated embodiment the MFP device 101 and the custom applications exchange UI instructions and user-entered data, respectively, in other embodiments an MFP device and custom applications may exchange other information through a proxy device. For example, custom applications may send data extracted from application specific databases, may omit UI instructions, may dynamically generated data, and so forth. Moreover, MFP devices may process user data and send the resultant product, may omit sending user data, may send static and/or dynamically generated data unrelated to the user-entered data, and so forth.

This process may be repeated until the host server 106 has received all of the user data. When the custom application has received all of the user data, the custom application directs the MFP device 101 to make the respective native functionality available to the user. For example, the custom application may direct the MFP device 101 to request a scanned image from the user. After receiving the scanned image, the custom application processes the user-submitted data, including the scanned image and the data entered in response to the UI screens. The custom application may, for example, extract data from the scanned image using optical character recognition (OCR) software, and then store the extracted data into a database. In some embodiments, certain custom applications may operate independently of the native functionality of an MFP device, receiving data through the user interface display without operating the native functions of the MFP, such as copying, printing, scanning, and/or faxing.

After processing the user-submitted data, the host server sends a return to home screen message in state 212, which is sent to the proxy device 104 and then onto the MFP device 101. At some point, an administrator may decide to un-register the APP1 custom application, as illustrated in state 214. Following the un-registration of the APP1 custom application, the MFP device 101 may send a regular update query to the proxy device 104. Upon receiving the update query, the proxy device 104 sends a message to the MFP device 101, informing the MFP device 101 that the APP1 custom application is no longer available.

FIG. 3 illustrates in greater detail the button response system. In state 302, the MFP device 101 receives an indication from a device user to initiate the respective custom application. In state 304, the proxy device 104 receives and sends a request for the next operations (or UI screens). In state 306, the custom application operating on a host server 106 receives the request for the next operations. In state 308, the custom application sends the next screen(s). In one embodiment, the screen instructions are XML-based UI templates. In state 310, the proxy device 104 receives the screen instructions from the host server 106 and sends them to the MFP device 101. In state 312, the MFP device 101 receives the next screen instructions and displays the next screen to the user of the MFP device 101. In state 314, the user enters data via the current display screen, and the MFP device 101 receives the data and sends it to the proxy device 104. In state 316, the proxy device receives the user-submitted data from the MFP device 101 and sends it to the host server 106. In state 318, the host server 106 receives the user submitted data and the respective custom application processes the data on the host server 106. If, as determined in state 320, all of the screens have been completed, then the custom application proceeds to state 322. If all of the screens have not been completed, then the custom application returns to state 308, sending the next screen, and waiting for the user submitted data in return.

In state 322, after the user-submitted data has been received, the custom application sends instructions to receive data from the native function of the MFP device. For example, the custom application may send instructions to receive scanned data from the MFP device 101. In state 324, the proxy device 104 receives the instructions from the host server 106 and sends them to the MFP device 101. In state 326, the MFP device 101 receives the instructions. In state 328, the MFP device requests from the user an image to be scanned, and sends the scanned data to the proxy device 104. In state 330, the proxy device 104 receives the scanned data from the MFP device 101 and sends it to the host server 106. In state 332, the host server 106 receives the scanned image. In state 334, the custom application processes the scanned image and sends instructions to the MFP device 101 to return to the home screen. In state 336, the proxy device 104 sends the instructions from the host server 106 to the MFP device 101. In state 338, the MFP device 101 receives the instructions to return to the home screen, and the MFP device 101, in state 340, returns to the home screen.

FIG. 4 illustrates one embodiment of a registration dialog window 400. As illustrated, the respective MFP device, “Device Name_1,” has two registered applications 402, called ePRO and Status Report, respectively. The registration dialog window includes a registration button 404 for registering new applications. The registration dialog window 400 also includes registration data fields 406. In the registration data fields 406, a user, such as an administrator, may enter the application name, a URL describing the location of the custom application (the Web Service address), and the relevant device, such as “Device Name_1.” When the user selects the “Apply” button, the registration service registers the new custom application. In the illustrated embodiment, the new custom application is called “Patent Process” and the new application is located at “//PatentWebService.” The registration dialog window 400 also includes un-registration data fields 408. To un-register the device, an administrator may enter the application ID of the registered device and click the un-register button.

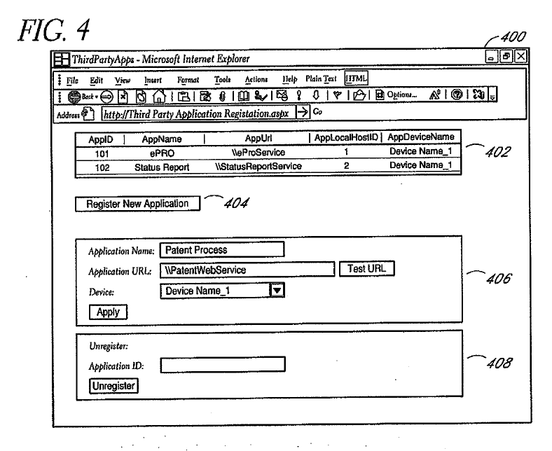

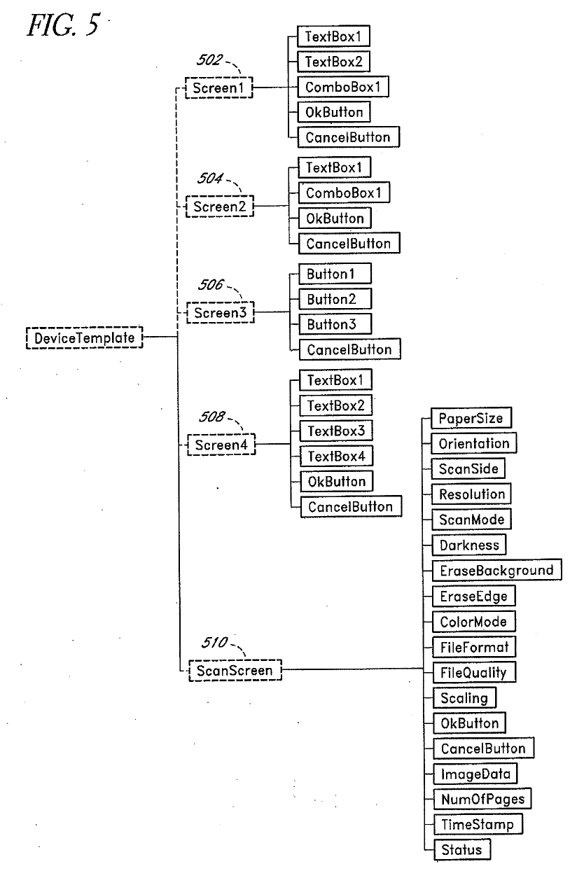

FIG. 5 illustrates one embodiment of possible UI templates. The UI template called Screen1 502 includes the following graphical interface features: TextBox1, TextBox2, ComboBox1, OkButton, and CancelButton. The UI template called Screen2 504 includes the following graphical user interface components: TextBox1, ComboBox1, OkButton and CancelButton. The UI template called Screen3 506 includes the following graphical user interface components: Button1, Button2, Button3, and CancelButton. The UI template called Screen4 508 includes the following graphical user interface components: TextBox1, TextBox2, TextBox3, TextBox4, OkButton and CancelButton. The UI template called ScanScreen 510 includes the following graphical user interface components: PaperSize, Orientation, ScanSide, Resolution, ScanMode, Darkness, EraseBackground, EraseEdge, Collate, FileFormat, FileQuality, Scaling, OkButton, CancelButton, ImageData, NumOfPages, TimeStamp, and Status.

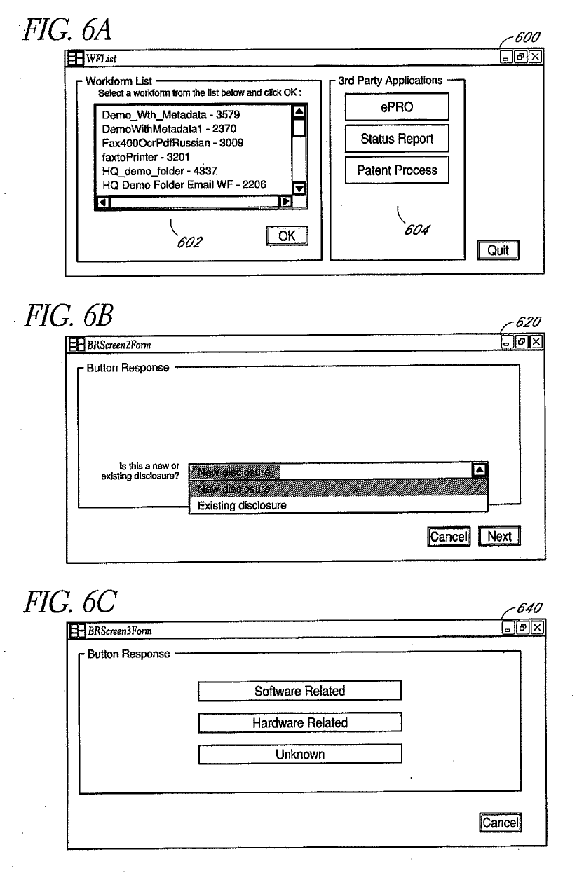

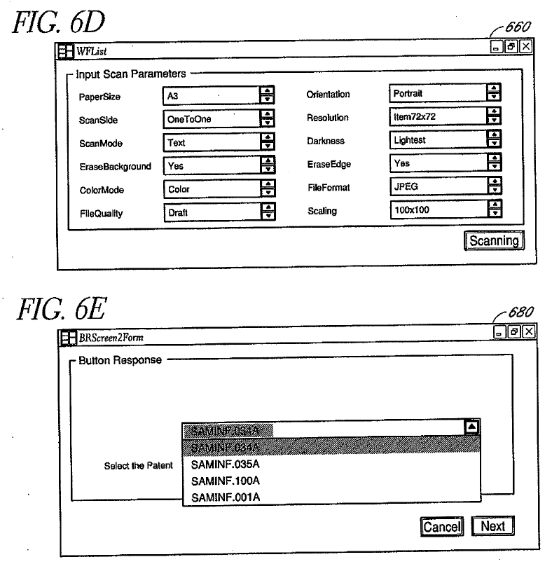

FIGS. 6A, 6B, 6C, 6D, and 6E illustrate possible embodiments of dialog windows corresponding to the UI templates illustrated in FIG. 5. In one embodiment, the dialog windows appear at the MFP device 101, through, for example, the device display screen. FIG. 6A illustrates one embodiment of an application dialog window 600 that illustrates a list of work flows 602 and available custom applications 604. FIGS. 6B, 6C, 6D and 6E correspond to dialog windows for the “Patent Process” custom application. The initial dialog window 620 prompts the user to choose between entering either a new disclosure or an existing disclosure. The initial dialog window 620 corresponds to Screen2 504 template. The type dialog 640 prompts the user to enter whether a new disclosure is related to software, is related to hardware, or is unknown (whether it relates to software or hardware). The type dialog window 640 corresponds to the Screen3 506 template. The scan dialog window 660 illustrates a number of data inputs corresponding to the custom application “Patent Process.” The existing disclosure dialog window 680 illustrates a group of the already existing disclosure. This dialog window appears if a user selects the “existing disclosure” option in the initial dialog window 620. The existing disclosure dialog window 680 corresponds to the Screen2 504 template.

Although this invention has been described in terms of certain embodiments, other embodiments that are apparent to those of ordinary skill in the art, including embodiments which do not provide all of the benefits and features set forth herein, are also within the scope of this invention. Accordingly, the scope of the present invention is defined only by reference to the appended claims.

What is claimed is:

1. A method of customizing multi-function peripherals (MFPs), the method comprising:
exposing functionality, through a software interface, of an MFP device to one or more custom applications hosted on one or more host devices remote to the MFP device; and
registering the one or more custom applications for use by users of the MFP device via a proxy device in communication with the one or more host devices.

2. The method of claim 1, wherein the software interface is described with the Web Service Description Language (WSDL), and wherein the one or more custom applications are Web Services.

3. The method of claim 1, wherein the software interface comprises definitions for XML-based user-interface templates available to the one or more custom applications.

4. A method of executing a custom application on a multi-function peripheral (MFP), the method comprising:
registering the custom application on a proxy device in data communication with the MFP;
making the registered custom application available to MFP users based on communication between the MFP and the proxy device;
receiving, via the MFP, data from an MFP user; and
routing, through the proxy device, the data from the MFP to a host device hosting the custom application.

5. The method of claim 4, further comprising exposing the functionality of the MFP to the custom application through a software interface described by the Web Service Description Language (WSDL), wherein the custom application is a Web Service available to MFP users.

6. The method of claim 4, further comprising receiving MFP user interface information routed from the host device to the MFP through the proxy device, wherein the user interface information comprises XML-based instructions from the custom application for configuring a user interface screen on the MFP, and wherein the user interface screen is configured to receive user data pertinent to the custom application.

7. A system for providing custom applications on multi-function peripherals (MFPs), the system comprising:
a proxy device, the proxy device configured to register the one or more custom applications for use by users of an MFP, wherein the MFP functionality is exposed, through a software interface, to one or more custom applications hosted on other devices.

8. The system of claim 7, wherein the software interface is described by the Web Service Description Language (WSDL).

9. The system of claim 7, wherein the software interface defines XML-based user-interface templates that the one or more custom applications may use to configure the user interface display of the MFP.

10. A multi-function peripheral (MFP) that supports custom applications, the MFP comprising:
an interface with one or more custom applications executed on other devices, the interface configured to make the one or more custom applications available to users of the MFP after receiving an update from a proxy device indicating that the proxy device has registered the one or more custom applications for use on the MFP.

11. The MFP of claim 10, wherein the interface uses the Web Service Description Language (WSDL), and wherein the custom applications are Web Services.

12. The MFP of claim 10, wherein the interface is configured to receive XML-based instructions to arrange the user interface display of the MFP, the XML-based instructions received from the one or more custom applications.

13. A method of providing custom applications on multi-function peripherals (MFPs), the method comprising:
defining a template for user input at an MFP, the template comprising a set of configurable user interface features;
receiving machine readable instructions originating from a custom application operating on a device other than the MFP, the machine readable instructions specifying user interface settings;
determining whether the received instructions correspond to the defined template; and
if there is a correspondence, configuring a user interface of the MFP based on the specified user interface settings.

14. The method of claim 13, wherein the template is defined using the Web Service Description Language (WSDL).

15. The method of claim 13, wherein the machine readable instructions are XML-based.

16. The method of claim 13, further comprising sending data, the data being provided by a user through the user interface, to the custom application, wherein the data is routed through a proxy device at which the custom application is registered.

17. A computer readable medium having machine loadable software for multi-function peripheral (MFP) application customization, wherein the software is configured to perform a method comprising:
defining a template for user input at an MFP, the template comprising a set of configurable user interface features;
receiving machine readable instructions originating from a custom application operating on a device other than the MFP, the machine readable instructions specifying user interface settings;
determining whether the received instructions correspond to the defined template; and
if there is a correspondence, configuring a user interface of the MFP based on the specified user interface settings.

18. A multi-function peripheral (MFP) that supports custom applications, the MFP comprising:
an interface with one or more custom applications executed on other devices, the interface configured to process XML-based instructions corresponding to one or more predefined templates that arrange the user interface display of the MFP, the XML-based instructions being received from the one or more custom applications.

19. The MFP of claim 18, wherein the interface uses the Web Service Description Language (WSDL), and wherein the custom applications are Web Services.

20. The MFP of claim 18, wherein the interface is configured to send data, the data being supplied by a user through the user interface display, to the one or more custom applications through a proxy device configured to register the one or more custom applications and to route communication between the MFP and the one or more custom applications.
